(19) United States
(12) Patent Application Publication
(10) Pub. No.: US 2025/0106253 A1
(43) Pub. Date: Mar. 27, 2025

(54) METHOD FOR GENERATING A HONEYPOT

(71) Applicant: Robert Bosch GmbH, Stuttgart (DE)

(72) Inventors: Dominik Germek, Berlin (DE); Niclas Ilg, Ammerbuch (DE)

(21) Appl. No.: 18/884,243

(22) Filed: Sep. 13, 2024

(30) Foreign Application Priority Data
Sep. 21, 2023 (DE) 102023209244.1

(51) Int. Cl. H04L 9/40

(52) U.S. Cl. CPC H04L 63/1491

(57) ABSTRACT

A method for generating a honeypot for a target system. The method includes ascertaining, by means of a honeypot generating device, which is granted access to the target system, the directory tree of a file system of the target system, operating system shell commands supported by the operating system and processes running on the target system by accessing the target system and generating, by means of the honeypot generating device, a honeypot, which contains a file system with a copy of the ascertained directory tree, imitates the ascertained shell commands and imitates the execution of the ascertained processes.

### FIELD

The present invention relates to a method for generating a honeypot.

### BACKGROUND INFORMATION

The number of networked data processing devices (including embedded devices) is increasing rapidly. An important aspect of all these devices-be they server computers on the Internet or control devices in the automotive or IoT sector-is product security. Honeypots are dummies that imitate such a valuable (target) system in order to attract attackers and gain information about their attack strategies and targets. Honeypots are an established tool for threat analysis, especially in corporate IT, and they are now also used in the area of the (industrial) Internet of Things ((I) IoT). Although honeypots are a very useful tool to complement the cybersecurity strategy, implementing honeypots for the specific needs and target system requires a lot of manual work by experts.

Therefore, approaches that enable easier provision (in particular configuration) of a suitable honeypot for a given target system are desirable.

### SUMMARY

According to various example embodiments of the present invention, a method for generating a honeypot for a target system is provided, comprising ascertaining, by means of a honeypot generating device, which is granted access to the target system,
the directory tree of a file system of the target system;
operating system shell commands supported by the operating system;
processes running on the target system (during operation) (and thus services supported by the target system, since internal processes also exist for these) by accessing the target system and generating, by means of the honeypot generating device, a honeypot, which contains a file system with a copy of the ascertained directory tree, imitates the ascertained shell commands and imitates the execution of the ascertained processes.

According to various example embodiments of the present invention, a honeypot generating device is granted access to the target system, wherein such access can be understood as such that the honeypot generating device can ascertain at least the mentioned information (directory tree, shell commands, running processes) (by exploring the target system, e.g. ascertaining the directory tree e.g. by a crawler, reading the running processes (e.g., accessing a task manager) and ascertaining the supported shell commands (e.g., reading a corresponding list). The honeypot generating device then generates a corresponding honeypot. Since the generation of the honeypot is based on detailed knowledge of the internal function or structure of the target system, the above approach can be viewed as white-box generation of a honeypot.

The method described above not only allows copying static content to a honeypot, but also dynamic parts of the target system, e.g. system services and command line tools, are explored and the honeypot is implemented so as to support them; i.e., an automatic imitation of substantially the entire functionality of an operating system (to the extent visible from the outside), including dynamic content, such as shell input, is effected with a honeypot. Thus, the generated honeypot does not only support a single service or a single protocol, but the generation of the honeypot aims to create an (at least approximately) complete imitation of the functionality of an operating system, wherein different operating systems can be imitated. This is particularly important in the world of embedded systems, where a large number of operating systems are used.

Various exemplary embodiments of the present invention are specified below.

Exemplary embodiment 1 is a method for generating a honeypot (for a predefined target system) as described above.

Exemplary embodiment 2 is the method according to exemplary embodiment 1, wherein the honeypot generating device checks a secrecy criterion for information ascertained by it through access to the target system and generates the honeypot in such a way that it does not contain information to be kept secret according to the secrecy criterion, which it ascertains through access to the target system.

The honeypot generating device can thus filter the information obtained and generate the honeypot based on the filtered information (i.e., without the filtered-out information). This particularly affects information from the file system (such as possibly specific files).

Exemplary embodiment 3 is the method according to exemplary embodiment 1 or 2, wherein the honeypot generating device generates the honeypot in such a way that it imitates the ascertained shell commands in such a way that their execution via a network interface of the honeypot is supported, wherein the honeypot supports the shell commands in a form such that, compared to their implementation on the target system, they lack functionalities that meet a predefined risk criterion (for example, are classified as dangerous for one or more other data processing devices according to the predefined risk criterion).

The honeypot generating device thus implements the shell commands in a “defused” form on the honeypot, in order to avoid damage caused by their implementation on the honeypot.

Exemplary embodiment 4 is the method according to one of exemplary embodiments 1 to 3, wherein the honeypot generating device ascertains information about the resource consumption of the ascertained processes on the target system and generates the honeypot in such a way that it imitates the ascertained processes in such a way that their resource consumption on the honeypot mimics the resource consumption they have on the target system.

This increases the credibility of the honeypot to a potential attacker.

Exemplary embodiment 5 is a data processing system with a honeypot generating device that is configured to carry out the method according to one of exemplary embodiments 1 to 4.

Exemplary embodiment 6 is a computer program comprising commands which, when executed by a processor, cause the processor to carry out a method according to one of exemplary embodiments 1 to 4.

Exemplary embodiment 7 is a computer-readable medium storing commands which, when executed by a processor, cause the processor to carry out a method according to one of exemplary embodiments 1 to 4.

In the figures, similar reference signs generally refer to the same parts throughout the various views. The figures are not necessarily true to scale, with emphasis instead generally being placed on the representation of the principles of the present invention. In the following description, various aspects are described with reference to the figures.

### BRIEF DESCRIPTION OF THE DRAWINGS

FIG. 1 shows a computer network, according to an example embodiment of the present invention.

FIG. 2 illustrates the sequence of generating and deploying a honeypot, according to an example embodiment of the present invention.

FIG. 3 shows the generation of a honeypot for a target system in greater detail, according to an example embodiment of the present invention.

FIG. 4 shows a flowchart illustrating a method for generating a honeypot for a target system according to one example embodiment of the present invention.

### DETAILED DESCRIPTION OF EXAMPLE EMBODIMENTS

The following detailed description relates to the figures, which show, by way of explanation, specific details and aspects of this disclosure in which the present invention can be executed. Other aspects may be used and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects.

Various examples are described in more detail below.

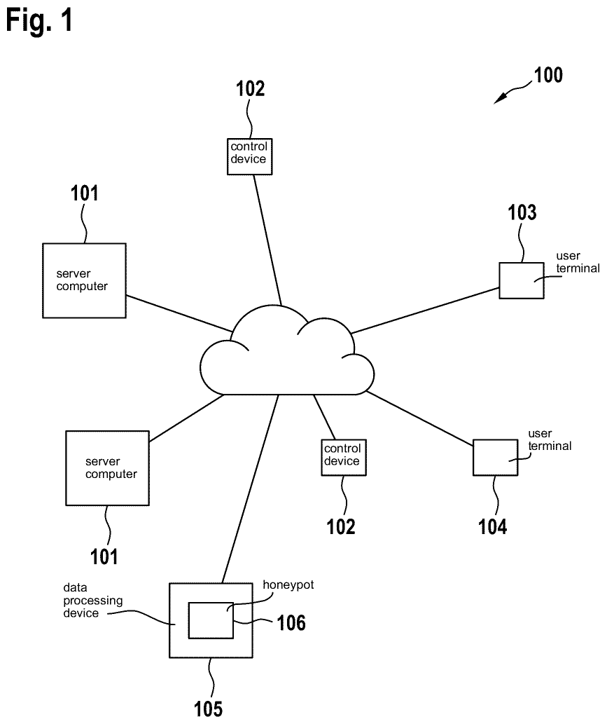

FIG. 1 shows a computer network 100. The computer network 100 includes a plurality of data processing devices 101-105, which are interconnected by communication links 106. The data processing devices 101-105 include, e.g., server computers 101 and control devices 102 along with user terminals 103, 104.

Server computers 101 provide various services, such as Internet sites, banking portals, etc. A control device 102 is, e.g., a control device for a robot device, such as a control device in an autonomous vehicle. The server computers 101 and control devices 102 thus fulfill different tasks and typically a server computer 101 or a control device 102 can be accessed from a user terminal 103, 104. This is particularly the case if a server computer 101 offers a functionality to a user, such as a banking portal. However, a control device 102 can also allow access from outside (e.g., so that it can be configured). Depending on the task of a server computer 101 or control device 102, they can store security-related data and execute security-related tasks. Accordingly, they must be protected against attackers. For example, an attacker using one of the user terminals 104 could, through a successful attack, gain possession of secret data (such as keys), manipulate accounts or even manipulate a control device 102 in such a way that an accident occurs.

A security measure against such attacks is a so-called honeypot 106 (which is implemented by one of the data processing devices 105). It seemingly provides a functionality and thus serves as bait to attract potential attackers. However, it is isolated from secret information or critical functionality, so that attacks on it are effected in a controlled environment and the risk of compromising the actual functionality is minimized. In this way, it makes it possible to gain knowledge about attacks on a target system (e.g., one of the server computers 101 or one of the control devices 102)—and thus the threat landscape—to which the implementation of suitable measures on the target system can respond, without these attacks endangering the target system.

Gaining insight into the threat landscape related to a specific device or product is a challenging task. Putting a real system in the hands of attackers to examine the attack path can provide a lot of information. However, sacrificing a real device is often not an option—such environments could be abused for later attacks or are expensive to maintain in large numbers. Therefore, medium-interaction honeypots are an alternative to these high-interaction environments. These medium-interaction honeypots are computer programs that pretend to be a real system. Since they emulate a system shell, file system, and services, medium-interaction honeypots attract attackers without compromising a real system. However, the implementation of such a real-looking environment, i.e. the provision of a honeypot for a specific (target) system (e.g., a server computer 101 or a control device 102) in such a way that it is credible for potential attackers, involves a lot of work. An engineer must manually adopt all the peculiarities of the emulated operating system. It also requires experience and/or detailed knowledge of honeypots.

According to various embodiments, an approach is therefore provided which makes it possible to automate the generation of a medium-interaction honeypot, i.e. to derive a medium-interaction honeypot environment from a system to be protected without manual implementation.

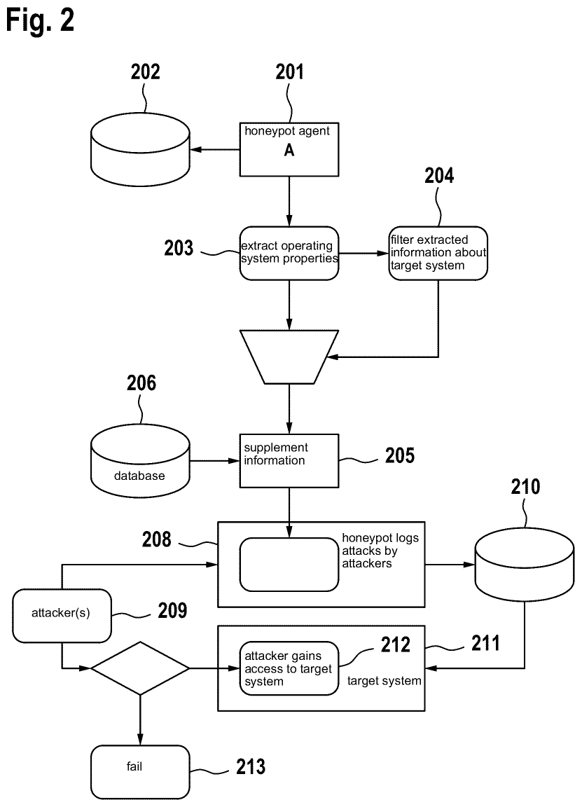

FIG. 2 illustrates the sequence of generating and deploying a honeypot (e.g., the honeypot 106).

The configuration is effected by means of a honeypot generating device 201 (implementing a “honeypot agent” A), which corresponds, for example, to one of the user terminals 104 (e.g. a computer with which a user (such as a system administrator) configures the honeypot 106 and instructs the data processing device 105 to provide the honeypot 106 thus configured).

The honeypot agent A gains physical access to (access to) a (critical, i.e., protected) target system. This can be effected independently of the operating system or services running on the target system. In 203, the honeypot agent A extracts operating system properties 202 of the target system (i.e., “samples” with respect to the target system) such as file system FS, shell commands Shl, internal processes procs and outward-facing services SV (i.e., services offered by the target system via a network interface of the target system).

In 204, the honeypot agent A filters the extracted information about the target system 202, i.e. removes from it sensitive data (e.g., data that must be kept secret and/or that damages the brand). In 205, the honeypot agent A can supplement (i.e., complete) information about the target system from previous investigations (from a database 206 with previous “samples”).

The honeypot generating device 201 then generates a honeypot 207 according to the (possibly filtered and completed) information.

During operation, the honeypot 208 logs attacks by attackers 209 for analysis in an attack log 210.

The logged attacks are analyzed and the information obtained is used to update the respective target system 211. Whether the security policies have been (appropriately) updated determines whether the attack of an attacker 209 on the target system 211 is successful (i.e., grants the attacker access 212 to the target system) or not (i.e., fails 213).

If an attacker can gain, e.g., physical access to a security-critical system, e.g. the engine control device of a vehicle, this can have serious consequences, e.g. leading to a fatal accident. A honeypot 208 generated according to the described approach makes it possible, for example, to protect vehicle components, e.g. a control device, from possible attacks by recognizing the attacks and protecting the vehicle components accordingly. For example, it can reduce the likelihood of car theft, the extraction of sensitive (user) driving data from a vehicle and the manipulation of features of the car (braking, lane changing, engine life, and other behaviors during manual or autonomous driving).

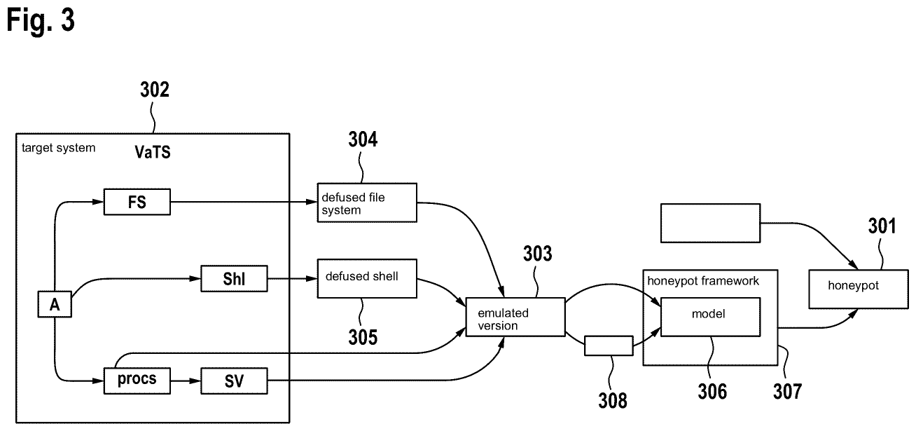

As explained above, the honeypot agent A in 203 extracts operating system properties of the target system 211, so that the generated honeypot 208 can correctly imitate the target system 211. This is described in more detail below with reference to FIG. 3.

FIG. 3 shows the generation of a honeypot 301 for a target system 302 in greater detail.

The honeypot agent explores (i.e., examines) the operating system (OS) of the target system 302, denoted by “VaTS” (for “valuable target system”) in FIG. 3, and creates an emulated version 303 of the operating system that correctly mimics it. According to one embodiment, the operating system components that the honeypot agent explores include at least the following:
File system FS: The honeypot agent not only copies the file system, but also recognizes and modifies sensitive data such that, for example, no secrets are present on the honeypot or made accessible by it. For example, the indexing of the file system is effected using a crawler that explores the entire file system and provides a detailed picture of the file system tree. In order to remove sensitive data (resulting in a filtered and thus “defused” file system 304), the honeypot agent can rely on pattern matching PM (e.g. “password file”) or use an appropriately trained machine learning model ML in order to reliably recognize and modify sensitive data.
Shell commands Shl: In order to enable an attacker to interact with the honeypot, the honeypot 301 should implement at least a subset of the shell commands of the target system 302. It should be noted that shell commands that cause harm to third parties (e.g., executing Python scripts, pinging third parties, scanning third party systems) are implemented in one embodiment in such a way that the attacker receives positive feedback when executing a shell command, but no real consequences are to be feared. The honeypot 301 is thus implemented in such a way that it realizes a defused shell 305: The attacker receives feedback on a shell command in the form of text, but the honeypot does not take any further steps to execute the shell command (at least not for critical shell commands). In order to implement the shell on the honeypot, the honeypot agent can use existing commands from the help or documentation of the target system 302. In order to identify and mitigate potentially dangerous commands, the honeypot agent can also use pattern matching of the command description or can be supported by machine learning.
Internal processes procs: In order to convincingly imitate the target system 302, the medium-interaction environment offered by the honeypot must adopt the internal processes of the target system. These can attract attackers because they provide clues about the nature of the system. In order to imitate realistic processes, the honeypot agent observes the internal processes of the target system 302 (e.g., ps in most Unix systems outputs a list of all internal processes). With this information, the honeypot agent can realistically recreate not only the processes but also their hardware utilization over time on the honeypot. It also recognizes processes that run external network services (e.g., sshd for SSH or ntpd for NTP).

From at least the above three components, the honeypot agent creates a model 306 of the target system 302, which it inserts into a honeypot framework 307 in order to generate the honeypot. In addition, it stores the model in a database 308 (which corresponds, e.g., to the database 206), which it can also use to supplement the model it has created (and ultimately the build for the honeypot 301) if the current model (or honeypot) is either missing a component or has already been built and only some components need to be rebuilt/updated. It can select earlier models (or builds) to complement a current honeypot, e.g. based on the similarity of the operating system. The framework 308 generates the medium-interaction honeypot 301 that imitates the target system 302 and collects data on how attackers 309 might attempt to attack the target system 302.

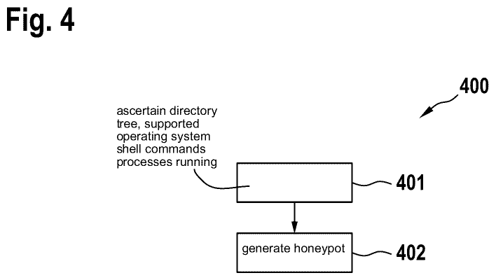

In summary, according to various embodiments, a method is provided as shown in FIG. 4.

FIG. 4 shows a flowchart 400 illustrating a method for generating a honeypot for a (predefined) target system according to one embodiment.

In 401, by means of a honeypot generating device, which is granted access to the target system (through appropriate control of the target system and/or assignment of corresponding access rights to the honeypot generation device),
the directory tree of a file system of the target system;
operating system shell commands supported by the operating system; and
processes running on the target system (during operation) (and thus services supported by the target system, since internal processes also exist for these) are ascertained by accessing the target system.

In 402, by means of the honeypot generating device, a honeypot is generated, which contains a file system with a copy of the ascertained directory tree, imitates the ascertained shell commands and imitates the execution of the ascertained processes.

The method of FIG. 4 can be carried out by one or more computers with one or more data processing units. The term “data processing unit” may be understood as any type of entity that allows for processing of data or signals. The data or signals can be treated, for example, according to at least one (i.e., one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail herein may also be understood as a data processing unit or logic circuit assembly. One or more of the method steps described in detail here can be executed (e.g., implemented) by a data processing unit by one or more special functions that are performed by the data processing unit.

The method is therefore in particular computer-implemented according to various embodiments.

1-7. (canceled)

8. A method for generating a honeypot for a target system, comprising the following steps:
ascertaining by accessesing the target system, using a honeypot generating device which is granted access to the target system:
the directory tree of a file system of the target system,
operating system shell commands supported by on operating system of the target device, and
processes running on the target system; and
generating, using the honeypot generating device, a honeypot which contains a file system with a copy of the ascertained directory tree, imitates the ascertained operating system shell commands, and imitates execution of the ascertained processes.

9. The method according to claim 8, wherein the honeypot generating device checks a secrecy criterion for information ascertained by it through access to the target and generates the honeypot in such a way that it does not contain information to be kept secret according to the secrecy criterion, which it ascertains through access to the target system.

10. The method according to claim 8, wherein the honeypot generating device generates the honeypot in such a way that it imitates the ascertained operating system shell commands in such a way that their execution via a network interface of the honeypot is supported, wherein the honeypot supports the ascertained operating shell commands in a form such that, compared to their implementation on the target system, they lack functionalities that meet a predefined risk criterion.

11. The method according to claim 8, wherein the honeypot generating device ascertains information about resource consumption of the ascertained processes on the target system and generates the honeypot in such a way that it imitates the ascertained processes in such a way that their resource consumption on the honeypot mimics the resource consumption they have on the target system.

12. A data processing system with a honeypot generating device which is configured to generate a honeypot for a target system, the honeypot generating device configured to:
ascertain by accessesing the target system, using the honeypot generating device which is granted access to the target system:
the directory tree of a file system of the target system,
operating system shell commands supported by on operating system of the target device, and
processes running on the target system; and
generating, using the honeypot generating device, a honeypot which contains a file system with a copy of the ascertained directory tree, imitates the ascertained operating system shell commands, and imitates execution of the ascertained processes.

13. A non-transitory computer-readable medium on which are stored commands for generating a honeypot for a target system, the commands, when executed by a processor, causing the processor to perform the following steps:
ascertaining by accessesing the target system, using a honeypot generating device which is granted access to the target system:
the directory tree of a file system of the target system,
operating system shell commands supported by on operating system of the target device, and
processes running on the target system; and
generating, using the honeypot generating device, a honeypot which contains a file system with a copy of the ascertained directory tree, imitates the ascertained operating system shell commands, and imitates execution of the ascertained processes.
